(19) United States
(12) Patent Application Publication
(10) Pub. No.: US 2026/0091742 A1
(43) Pub. Date: Apr. 2, 2026

(54) COMBINATION OF TRAILER BRAKING AND LIGHTING FUNCTIONS

(71) Applicant: HORIZON GLOBAL AMERICAS INC., Plymouth, MI (US)

(72) Inventors: Nicholas Albert CEKOLA, Plymouth, MI (US); Dennis Michael MORSE, Plymouth, MI (US); Marvin HOOT, Plymouth, MI (US); Yilong CHEN, Plymouth, MI (US); Srikanth KADUDULA, Plymouth, MI (US); Leon BOGDANOV, Plymouth, MI (US); George MOORE, Plymouth, MI (US)

(73) Assignee: HORIZON GLOBAL AMERICAS INC., Plymouth, MI (US)

(21) Appl. No.: 19/404,408

(22) Filed: Dec. 1, 2025

Related U.S. Application Data
(63) Continuation of application No. 17/745,589, filed on May 16, 2022, now Pat. No. 12,485,837.
Application No. 17/745,589 is a continuation of application No. 15/707,385, filed on Sep. 18, 2017, now abandoned.
(60) Provisional application No. 62/395,550, filed on Sep. 16, 2016.

(51) Int. Cl. B60R 16/023; B60Q 1/00; B60Q 1/22; B60Q 1/30; B60Q 1/34; B60Q 1/44; B60R 16/033; B60T 7/20; B60T 13/66; B60T 17/22

(52) U.S. Cl. CPC B60R 16/0231; B60Q 1/0094; B60Q 1/305; B60Q 1/44; B60R 16/033; B60T 7/20; B60T 13/662; B60T 17/22; B60Q 1/22; B60Q 1/34

(57) ABSTRACT

A towed vehicle controller integrates trailer braking, lighting, and battery charging functions into a single unit communicatively coupled to a towing vehicle data bus. The controller includes a processor, a trailer brake controller component, a trailer lighting component with multiple light drivers, and a trailer battery charge component. The processor receives inputs via the vehicle communication bus and other interfaces, executes brake control algorithms, coordinates activation of trailer lamps, and manages trailer battery charging, including foregoing charging based on braking state or vehicle conditions. Integration of these functions reduces wiring and component count, facilitates OEM or aftermarket installation, and enables coordinated control, diagnostics, and display of trailer status through the towing vehicle's existing electronic systems.

### CROSS-REFERENCE TO RELATED APPLICATION

The present application is a continuation of and claims the benefit of U.S. patent application Ser. No. 17/745,589 filed on May 16, 2022, which is a continuation of and claims the benefit of U.S. patent application Ser. No. 15/707,385 filed on Sep. 18, 2017, which claims the benefit of U.S. Provisional Patent Application Ser. No. 62/395,550 filed Sep. 16, 2016, each of which is incorporated herein by reference in its entirety and for all purposes.

### FIELD OF THE DISCLOSURE

The present disclosure relates generally to brake controllers, and more specifically, to a system that combines functions of a brake controller and lighting module of a towed vehicle.

### BACKGROUND OF THE DISCLOSURE

A variety of prior art brake control units that provide a brake output signal to the brakes of a towed vehicle have been proposed and/or manufactured. One example of such a brake control unit is provided by U.S. Pat. No. 8,746,812, which is incorporated by reference in its entirety.

Most current brake control units are not integral with the towing vehicle. They are aftermarket units that are positioned in the towing vehicle in any available space. Moreover, lighting modules and trailer battery charge functions are not integral with the towing vehicle. This results in multiple different components having to be integrated with or otherwise attached to a towing vehicle. Further still, these systems do not communicate with one another, take up additional space and often require significant time and effort to operatively attach.

Therefore, there is a need for a more efficient trailer brake controller that may incorporate towed vehicle braking control, towed vehicle lighting, and towed vehicle battery charge functions into a single unit.

### SUMMARY OF THE DISCLOSURE

Disclosed is a single towed vehicle controller that receives inputs (such as through discrete, analog, CAN and/or LIN) to determine braking of the towed vehicle, lighting of the towed vehicle, and towed vehicle battery charge functions. The towed vehicle controller may perform as a trailer brake controller, contain all possible combinations of lighting for a trailer, and operate as a trailer battery charger. The present disclosure describes a combination of a trailer brake controller, lighting module, and battery charger.

A towed vehicle controller is disclosed. The towed vehicle controller includes a processor comprising a memory device, a brake controller component coupled to the processor, and operatively generating a signal to be sent to trailer brakes, a trailer lighting component coupled to the processor and operatively comprising one or more light drivers that generate signals to control trailer lights and a trailer battery charge component coupled to the processor, and operatively generating a signal to be sent to a trailer battery.

A towed vehicle controller system is also disclosed. The towed vehicle controller system includes a communication bus of a towing vehicle, and a towed vehicle controller communicatively coupled to the communication bus. The towed vehicle controller includes a trailer brake control circuit that operatively and selectively generates a signal to induce braking in a towed vehicle's brakes, a lamp driver circuit that operatively and selectively drives lamps of a towed vehicle, and a trailer battery charging circuit that operatively and selectively controls charging of a towed vehicle battery. The communication bus provides input to the towed vehicle controller and the towed vehicle controller controls at least one of the trailer brake control circuit, the lamp driver circuit, and the trailer battery charging circuit based on the input.

A towed vehicle controller system including a communication bus of a towing vehicle and a towed vehicle controller communicatively coupled to the communication bus is also disclosed. The towed vehicle controller includes a trailer brake control circuit that operatively and selectively generates a signal to induce braking in a towed vehicle's brakes, a lamp driver circuit that operatively and selectively drives lamps of a towed vehicle, and a processor coupled to the trailer brake control circuit and lamp driver circuit, wherein the processor operatively controls the trailer brake control circuit and lamp driver circuit.

### BRIEF DESCRIPTION OF THE DRAWINGS

Objects and advantages together with the operation of the present teachings may be better understood by reference to the following detailed description taken in connection with the following illustrations, wherein:

FIG. 1 is a block diagram of an exemplary embodiment of a towed vehicle controller comprising a trailer brake controller component, a trailer lighting component, and a trailer battery charge component;

FIG. 2 is the block diagram of FIG. 1 identifying the towed vehicle controller comprising a trailer brake controller component, a trailer lighting component, and trailer battery charge component;

FIG. 3 is a plan view of circuitry of the combination trailer brake controller and lighting module device; and

FIG. 4 is an exemplary method for controlling the trailer brakes, trailer lights, and trailer battery of a towed vehicle.

### DETAILED DESCRIPTION

Reference will now be made in detail to exemplary embodiments of the present teachings, examples of which are illustrated in the accompanying drawings. It is to be understood that other embodiments may be utilized and structural and functional changes may be made without departing from the respective scope of the present teachings. Moreover, features of the various embodiments may be combined or altered without departing from the scope of the present teachings. As such, the following description is presented by way of illustration only and should not limit in any way the various alternatives and modifications that may be made to the illustrated embodiments and still be within the spirit and scope of the present teachings.

As used herein, the words “example” and “exemplary” mean an instance, or illustration. The words “example” or “exemplary” or terms of similar import do not indicate a key or preferred aspect or embodiment. The word “or” is intended to be inclusive rather than exclusive, unless context suggests otherwise. As an example, the phrase “A employs B or C,” includes any inclusive permutation (e.g., A employs B; A employs C; or A employs both B and C). As another matter, the articles “a” and “an” are generally intended to mean “one or more” unless context suggests otherwise.

“Logic” refers to any information and/or data that may be applied to direct the operation of a processor. Logic may be formed from instruction signals stored in a memory (e.g., a non-transitory memory). Software is one example of logic. In another aspect, logic may include hardware, alone or in combination with software. For instance, logic may include digital and/or analog hardware circuits, such as hardware circuits comprising logical gates (e.g., AND, OR, XOR, NAND, NOR, and other logical operations). Furthermore, logic may be programmed and/or include aspects of various devices and is not limited to a single device.

The terms “component,” “module,” “system,” “interface,” “platform,” “service,” “framework,” “connector,” “controller,” or the like are generally intended to refer to a computer-related entity. Such terms may refer to at least one of hardware, software, or software in execution. For example, a component may include a computer process running on a processor, a processor, a device, a process, a computer thread, or the like. In another aspect, such terms may include both an application running on a processor and a processor.

In an aspect, the towed vehicle controller may comprise a system that integrates a trailer brake controller, lighting module, and a trailer battery charger into a single unit. In some traditional systems, these different components are independent of each other. As such, each component had separate connections and took up its own physical space in a vehicle.

Disclosed is a towed vehicle control system that may include a single towed vehicle controller that receives inputs (such as through discrete, analog, CAN (Controller Area Network) and/or LIN (Local Interconnect Network)) to control braking of the towed vehicle (e.g., a trailer, such as an agriculture trailer, flat bed trailer, recreational trailer, or the like), lighting of the towed vehicle, and charging of the towed vehicle battery. The towed vehicle controller may include a trailer brake controller component that may include circuitry that operatively controls the brakes of a trailer, a trailer lighting component that may include circuitry to control various combinations of a trailer's lights, and a trailer battery charge component that may include circuitry to operatively control charging of a trailer's battery.

In described embodiments, the trailer brake controller component may be used with a towed vehicle, e.g., a trailer, to operatively control the brakes of the towed vehicle. The trailer brake control controller component may generate an output signal and may initiate transmission of the output signal to the brakes of the towed vehicle. The output signal may induce the brakes to apply a certain brake load thereto. The output signal may be related to a variety of input signals received by the brake controller from the towing vehicle, the towed vehicle, the operator, or any combination thereof. The towed vehicle controller may initiate transmission of signals that control the lights of the towed vehicle based at least in part on the output signal for the brakes of the towed vehicle. For instance, the towed vehicle controller may generate the output signal to the trailer brakes and generate a signal to the brake lights of the trailer to induce activation of the brake lights and brakes of the towed vehicle.

The towed vehicle controller may be an original equipment manufactured (OEM) unit that is installed in the towing vehicle at the factory. Alternatively or additionally, the towed vehicle controller may be incorporated into the towing vehicle as an after-market component. The towed vehicle controller may be combined in a single unit that operates the brakes of the towed vehicle, lights of the towed vehicle, and the battery of the towed vehicle. This may reduce the number of components utilized in the towing vehicle, which may make it easier, cost effective, and more efficient to install. Moreover, this may allow such system to be incorporated into the towing vehicle at the time of manufacture.

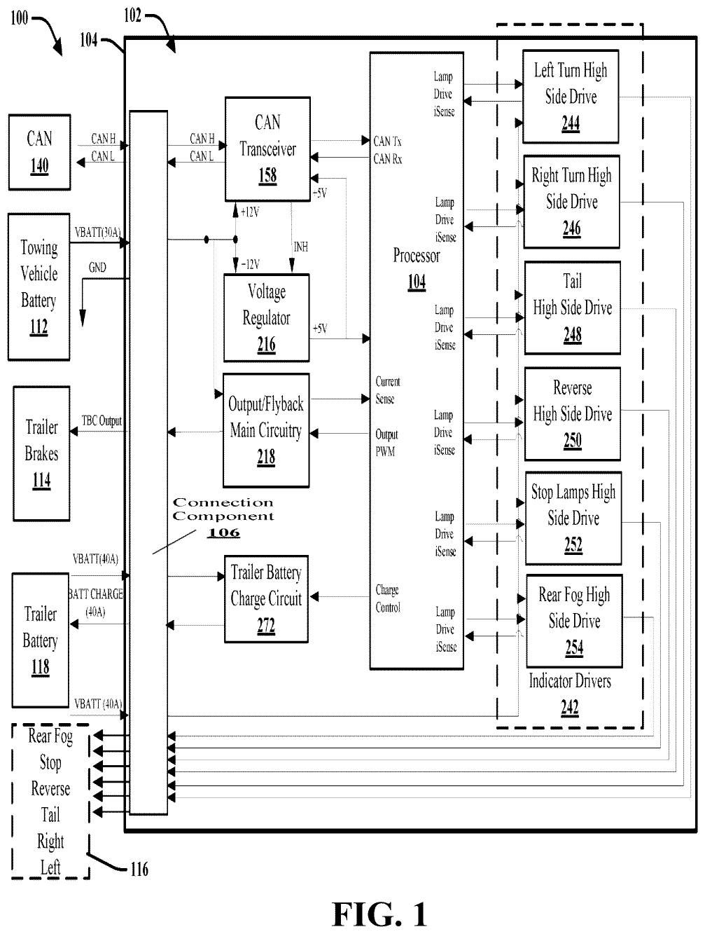

The towed vehicle control system may include a towed vehicle controller and a communications network coupled to the towed vehicle controller. For instance, the towed vehicle control system may include a CAN bus (and/or discrete, analog and/or LIN connections) that is communicatively coupled to the towed vehicle controller and other components of the towing vehicle (e.g., ABS devices, sensors, displays, brake pedals, automatic braking by a vehicle, etc.). The towed vehicle controller may receive inputs over the CAN bus or the like to determine or control towed vehicle braking, towed vehicle lighting and towed vehicle battery charge functions. An exemplary embodiment of such system is shown in FIG. 1, which depicts a global module. The global module comprises various possible combinations of lighting for the towed vehicle, which may be any type of towed vehicle. In at least one embodiment, the global module may comprise all or generally all possible combinations of lighting for the towed vehicle. In at least some embodiments, the towed vehicle controller may comprise a depopulated version that includes sets or subsets of lighting that may be used to accommodate the needs for different global markets and/or different towed vehicles. For example, certain markets may not utilize or may prohibit activation of certain trailer lights. In these markets, the towed vehicle controller may include connections and/or circuitry for control of the appropriate lights.

More specifically as shown in FIG. 1, a towed vehicle control system 100 that primarily comprises a towed vehicle controller 102 is shown. The towed vehicle controller 102 may be generally housed in a single housing or enclosure 104. The housing or enclosure 104 may be integrated with the towing vehicle as an original equipment portion or may be added as an after-market component. The housing or enclosure 104 may be part of another housing or enclosure of the towing vehicle, such as a housing for other electrical components of the towing vehicle. Alternatively, a housing or enclosure 104 may not be utilized. For instance, the system may be directly and operatively connected with the towing vehicle without a housing for the electrical components. Further still, the housing or enclosure 104 may be operatively attached to the towing vehicle in any appropriate way, such as within a dash or control console.

The towed vehicle controller 102 may include a connection component 106. The connection component 106 is the conduit through which generally all input and output signals are sent to and from the towed vehicle controller 102 to the towing vehicle and/or towed vehicle. The connection component 106 may include one or more headers or electrical connectors. According to an embodiment, the connection component 106 may comprise a single electrical connector (e.g., a serial port) that comprises a plurality of electrical connectors operatively coupled together. As shown, the connection component 106 may operatively couple the towed vehicle controller 102 with a CAN 140 of the towing vehicle, the towing vehicle battery 112, trailer brakes 114, trailer lights 116, and a trailer battery 118. By way of a non-limiting example, the system 100 may receive and send signals via the CAN 140, which may comprise a high-speed CAN (HSCAN) or the like. The CAN 140 may comprise a vehicle's OEM CAN. In another aspect, the CAN 140 may comprise an aftermarket addition to a vehicle. It is noted that, as described here as well as elsewhere in this disclosure, the system 100 may utilize various other networks or communication systems within the towing vehicle other than or in addition to CAN 140. Embodiments, however, refer to CAN 140 for sake of brevity.

In at least some embodiments, the connection component 106 may be wiredly coupled with the towing vehicle. Further, in some embodiments the connection component 106 may be wirelessly coupled with the towing vehicle. For instance, the connection component 106 may comprise a wireless transceiver/receiver. In at least one aspect, the connection component 106 may comprise a combination of wired and wireless connection devices.

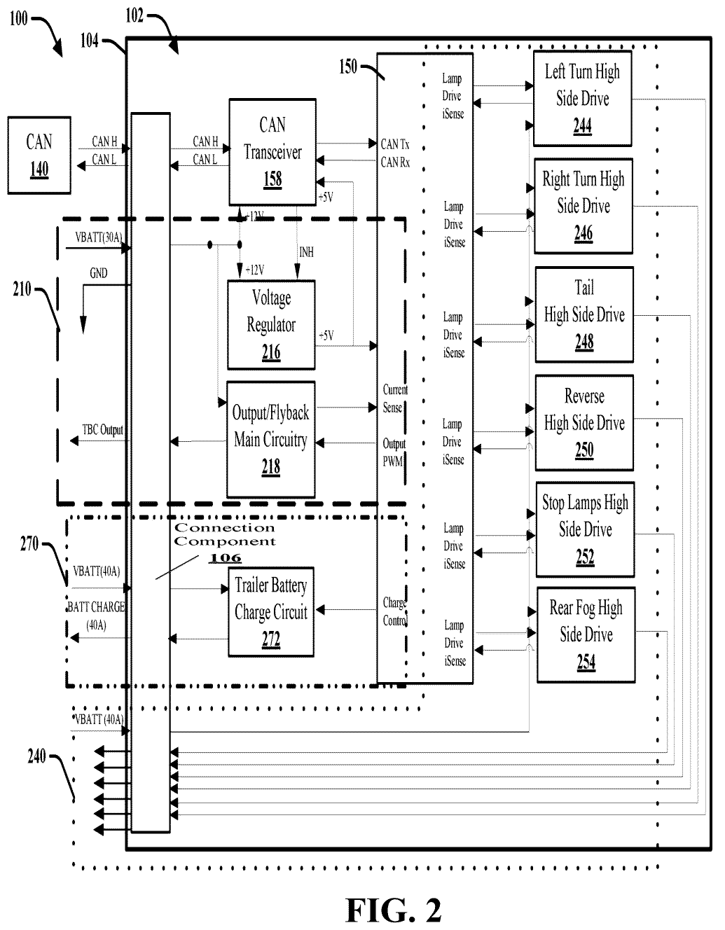

Turning to FIG. 2, with reference to FIG. 1, system 100 is annotated to illustrate circuitry that may comprise the trailer braking component 210, trailer lighting component 240, and trailer battery charge component 270. It is noted that the components 210, 240, and 270 may comprise appropriate electrical circuits. In another aspect, the components 210, 240, and 270 may comprise or communicate with a processor 150. The processor 150 may include a memory device that may be configured for storing computer executable components or instructions. Processor 150 may facilitate operation of the computer executable instructions. In an aspect, the instructions may control charging of the towed vehicle battery 118, brake application of the trailer brakes 114, lighting of the trailer lights 116, and/or user interface devices.

The processor 150 may be of any appropriate configuration. The processor 150 may operate as a processor or controller for various portions of the towed vehicle controller 102, e.g., the trailer braking component 210, trailer lighting component 240, and trailer battery charge component 270. As used herein, the term “processor” may include a general-purpose processor, a microcontroller (e.g., an execution unit with memory, etc., integrated within an integrated circuit), a digital signal processor (DSP), a programmable logic device (PLD), or an application specific integrated circuit (ASIC), among other processing devices. The processor 150 generally includes sufficient on-board memory to contain the software requirements to communicate with the towing vehicle's communication bus (such as the CAN 140), or other communication systems (such as a LIN and a J1850), in-vehicle diagnostics, and required functionality for interpreting vehicle and driver inputs. In some embodiments, the system 100 may include external memory coupled to the processor 150. In another aspect, the processor 150 may provide proper control to the: trailer brakes 114, trailer lights 116, trailer battery 118, and interfaces (e.g., dash displays that display information accessible to the operator). The processor 150 may be operably coupled (e.g., via the connection component 106) to a display driver, a manual control override, gain up/down controls, sensitivity controls, and the like.

The towed vehicle controller 102 may include a CAN transceiver 158. As noted above, embodiments may refer to a particular communications network for sake of brevity. Thus, while this disclosure may reference CAN transceiver 158, the towed vehicle controller 102 may include other input circuits that may operatively receive input from an appropriate network. For example, the towed vehicle controller 102 may include a wired or wireless transceiver operative for an appropriate communications protocol. It is noted that the towed vehicle controller 102 may extract data from the CAN 140 as well as transmit information to the CAN 140 to interface with other subsystems in the towing vehicle, e.g., cluster, ABS, vehicle stability systems, transmissions, dimming features, etc. The towed vehicle controller 102 is in constant communication with the CAN 140.

It is noted that the CAN transceiver 158 may be operatively coupled with the connection component 106 and the processor 150. The CAN transceiver 158 may receive and send input and output signals to the towing vehicle CAN 140 through the connection component 106. These input/outputs may operate the trailer brake controller component 210 trailer lighting component 240, and/or trailer battery charge component 270. Further, the CAN transceiver 158 may send and receive input and output signals to and from the processor 150 related to operation of the trailer brake controller component 210, trailer lighting component 240, and/or trailer battery charge component 270. These input and output signals may operate any one of the trailer brake controller component 210, trailer lighting component 240, trailer battery charge component 270, and/or user interfaces. In an example, the processor 150 may send output to CAN transceiver 158 that includes information regarding properties or parameters of related to the towed vehicle (e.g., connectivity status, brake application, light application, battery charging, etc.). The CAN transceiver 158 may generate output that is sent to the CAN 140 through the connection component 106. CAN 140 may deliver the information to appropriate devices within the towing vehicle. For instance, a towing vehicle may comprise a touch screen or LCD screen display that renders information to the user. The CAN 140 may provide information to the display (or a display controller that operatively controls the display) to cause the display to render the information for the user.

The brake controller component 210 may include a voltage regulator 216 of any appropriate configuration. The voltage regulator 216 may be operatively coupled with the towing vehicle battery 112 through the connection component 106 and operatively coupled with the processor 150 in any appropriate matter. Further, as shown in FIG. 1, the towed vehicle controller 102 may include an output/flyback main circuitry 218, which provides the trailer brake control output to the trailer brakes 114 through the connection component 106. The processor 150 may be operatively coupled with the output/flyback main circuitry 218 in any appropriate manner.

The output/flyback main circuitry 218 may operatively apply power from the towing vehicle battery 112 (or other power source) to the trailer brakes 114 in accordance with a brake control output from the processor 150. In another aspect, the output/flyback main circuitry 218 may provide feedback information to the processor 150 regarding the amount of current/voltage/power sent to the trailer brakes 114, connectivity status of the trailer brakes 114, short circuit identification, or the like. In an example, the output/flyback main circuitry 218 may include a current sensing circuit that senses the amount of current operatively sent to the trailer brakes 114. The processor 150 may compare the sensed current to the amount of current that should have been sent if the trailer brakes 114 were properly connected. This may allow the processor 150 to determine whether a short has occurred. In another aspect, the processor 150 may generate instructions that may be utilized to cause a display to render information related to the sensed current (e.g., indication of amount of braking, connectivity status, etc.).

The trailer battery charge component 270 may include a trailer battery charge circuit 272. The trailer battery charge circuit 272 may be operatively coupled between the connection component 106 and the processor 150 in any appropriate manner. The trailer battery charge circuit 272 may operate trailer battery charge functions. For instance, the processor 150 may receive inputs to identify when to charge a battery of the towed vehicle. This may include user provided inputs, measured levels of the towed vehicle battery, measured levels of the towing vehicle battery, demands on the towing vehicle battery and the like.

In an example, the trailer battery charge component 270 may operatively charge the towed vehicle battery through a charge control output sent from the processor 150 and received by the trailer battery charge circuit. The charge control output may induce charging of the towed vehicle battery. It is noted that the processor 150 may operatively charge the towed vehicle battery when demands on the towing vehicle battery are below a threshold or at non-peak demand times. For instance, when the towing vehicle is actively applying a signal to induce braking of the towed vehicle, the processor 150 may forgo charging. In another aspect, the processor 150 may provide information regarding the charging of the trailer battery 118 via the CAN 140 to other devices of the towing vehicle (e.g., such as a display).

In another aspect, the trailer light component 240 of the towed vehicle controller 102 may include one or more towed vehicle indicator drivers 242 that operatively drive appropriate trailer lights 116. For instance, the towed vehicle controller 102 may include a left turn indicator high side driver 244 (that may drive a left turn signal light or lamp of the towed vehicle), a right turn indicator side driver 246 (that may drive a right turn signal light or lamp of the towed vehicle), a tail indicator side driver 248 (that may drive a tail light or lamp of the towed vehicle), a reverse indicator side driver 250 (that may drive a reverse light or lamp of the towed vehicle), a stop indicator side driver 252 (that may drive a stop light or lamp of the towed vehicle), and a rear fog indicator side driver 254 (that may drive a rear fog light or lamp of the towed vehicle). It should be understood, however, that these are merely exemplary and the present disclosure is not limited to these. Any appropriate light driver and trailer lights 116 may be utilized without departing from the present teachings. Each of the light drivers may be operatively coupled with the processor 150 to receive and/or send input and output signals to operate such applicable lights. The towed vehicle indicator drivers 242 may be operatively coupled with the connection component 106, the processor 150, and/or a power source (e.g., a towed/towing vehicle batter) in any appropriate manner.

The processor 150 may control or coordinate activation of the various trailer lights 116 based on inputs received from the CAN 140 and/or outputs calculated by the processor 150. For instance, the CAN 140 may communicate a user induced activation of a light (e.g., the user turns on a turn signal, places the vehicle in reverse, presses the hazard lights, etc.). The processor 150 may receive this information from the CAN 140 and may appropriately drive one or more of the towed vehicle indicator drivers 242. In another aspect, the processor 150 may activate towed vehicle indicator drivers 242 based on application of the trailer brakes 114 via the trailer brake controller component 210 as described herein.

As described herein, the trailer brake controller component 210 may operatively control the trailer brakes 114. The trailer brake controller component 210 may be grounded as means of protection and safety. The trailer brake controller component 210 may be operatively coupled to the trailer battery 118 or other power supply. This may allow the trailer brake controller component 210 to selectively apply an appropriate amount of power to the trailer brakes 114.

It is noted that the trailer brake controller component 210 may operatively control the trailer brakes 114 based on various inputs as described herein. For instance, the trailer brake controller component 210 may operatively control the amount of braking induced in the trailer brake controller component 210 based on a predetermined pattern(s), a time-based pattern, user inputs, or the like, as described below. For instance, the trailer brake controller component 210 may control the brakes according to one or more algorithms or patterns stored in a memory of the processor 150. For instance, the trailer brake controller component 210 may operatively proportion the amount and time of braking induced by the trailer brake controller component 210 based on measured forces (e.g., inclination, acceleration, temperature, wheel speed sensors, ABS information, etc.).

As an example, the trailer brake controller component 210 can receive and send signals relating to wheel speeds of the towing (e.g., via the CAN 140) and/or towed vehicle, forces measured by sensors (e.g., accelerometers, gyroscopes, etc.), vehicle state information from ABS, brake-on-off, etc. The trailer brake controller component 210 can also receive signals from the brake pressure transducer (BPT) of the towing vehicle, and can also receive a power signal. In an aspect, the processor 150 may operatively receive the input(s) and generate a brake control output.

The brake control output may comprise one or more signals that may control the amount of braking induced in the trailer brakes 114. It is noted that the brake control output may comprise a pulse width modulated (PWM) signal or other appropriate signal. In at least one embodiment, the output/flyback main circuitry 218 may receive the brake control output and may, in turn, generate an appropriate brake output signal (e.g., the signal to be sent to the trailer brakes 114) via the connection component 106. For instance, the output/flyback main circuitry 218 may generate or vary the current and/or voltage of a signal to be sent to the trailer brakes 114 based on the brake control output received from the processor 150. The properties of the signal to be sent to the trailer brakes 114 may adjust the amount of braking induced at the trailer brakes 114.

As noted, the trailer brake controller component 210 may use a variety of preselected or continuously modified algorithms to generate the appropriate output to the towed vehicle brakes based on the received inputs. The processor 150 may receive the input signals from the source (such as the ABS system, a speed meter, the ignition, the brake pedal, other processors on the towing vehicle, etc.) and generates the appropriate output signal. The algorithms stored within the processor 150 may be updated by having new algorithms entered therein or having the existing algorithms modified automatically or manually. It should be noted that the towed vehicle controller 102 may be capable of being reprogrammed meaning that the algorithms stored therein can be modified by a technician or a completely new set of algorithms may be entered therein by a technician. This allows the towed vehicle controller 102 to be updated with new information regarding the towing vehicle, the towed vehicle, or the brake controller itself. The algorithms stored in the towed vehicle controller 102 may correspond to each unique combination of inputs. The selection of the appropriate algorithm or algorithms is done by the processor once it receives the appropriate input information. Further, depending upon changes in the input(s), the processor may select a different algorithm or algorithms to generate the appropriate brake output signal. Of course, the processor 150 or a technician/operator may alter the algorithms stored to generate an appropriate brake output signal.

Additionally, the towed vehicle controller 102 may receive an input signal from the brake pressure transducer (BPT). The BPT input signal can be received via the CAN 140. This input signal represents the braking effort by the operator. The brake controller can also receive an input signal from the towing vehicle's anti-lock braking system (ABS) to adjust the application of the towed vehicle's brakes. In particular, the algorithm applies the ABS signal of the towing vehicle and responds to that signal by altering the brakes of the towed vehicle based on the ABS event. For example, the algorithm can cause the towed vehicle to continue to fully brake if the ABS is triggered due to wheel slip on a high p surface, or can be used to reduce the braking to the towed vehicle if the ABS condition results from braking on a low or split p surface.

It is noted that the processor 150 may determine the brake output control based on various identified inputs as described herein. In another aspect, the processor 150 may determine the brake output control based on inputs and user specified parameters. For instance, a user may identify and enter via user interfaces a selected predetermined algorithms, modifiable algorithms, or both. In particular, an operator can manually enter an input and the brake controller can output a brake output signal that can apply the brakes of the towed vehicle in a predetermined manner based on such input.

For instance, the towed vehicle controller 102 may comprise user interfaces that allow an operator to select a gain, sensitivity, manual braking intensity, maximum/minimum duty cycle (e.g., power output), or the like. The user interfaces may be coupled to the CAN 140 and/or may be wired or wirelessly coupled to the connection component 106.

Interfaces can provide several different inputs to the towed vehicle controller 102. For example, interfaces may include buttons that allow a user to turn features on/off (e.g., turn on/off brake controller features, lights, battery charging, etc.) In another aspect, user interfaces may include buttons that allow a user to change types of towed vehicle braking patterns (e.g., electric brake curves to electric over hydraulic algorithms). Since the load sensing and performance curves are significantly different for the two types of braking systems, this allows for adapting the towed vehicle controller 102 via the operator input to a unique algorithm(s) for electric over hydraulic brakes. Also, the display can show the use of the alternate configurations to notify the operator of the configuration currently set. For example, a flashing digital character representation or other visual indicator may show that the brake controller is interfacing to an electric over hydraulic braking system.

In another aspect, the towed vehicle controller 102 may adjust the maximum duty cycle available based on user input. More specifically, if manual activation occurs during a normal or ABS braking event, the greater of the two duty cycles, i.e., a normal ABS event or a limited operating strategy (LOS) deceleration braking event, is used. The determined duty cycle is then adjusted according to the current gain setting. The gain setting is used as a multiplier to the duty cycle. Therefore, it will produce an output that is scaled to a certain percentage of the current braking level the operator is requesting. For example, if the operator is requesting 75% desired braking capacity at a gain setting of 6.0, the brake controller will provide 45% of the maximum duty cycle available (60% times 75%).

According to another example, the trailer brake controller component 210 may adjust the brake control output based on a reference speed, inclination, or other sensed parameters associated with the towing or towed vehicle. For instance, the trailer brake controller component 210 may scale a gain adjusted duty cycle output according to the towing vehicle speed and/or inclination. At low speeds, a scaled percentage of the brake output control is computed based on a curve that is present in a lookup table present in the processor. This thereby causes reduced braking strength at lower speeds to prevent the brakes of the towed vehicle from jerking. At higher speeds, the brake output signal is set to 100% of calculated duty cycle. This duty cycle value is stored to be used for the output display on the towing vehicle display. The unadjusted value of this signal may be displayed, thereby, communicating to the operator the total level of braking requested at a specific gain setting.

In another example, the trailer brake controller component 210 may apply brakes based on a manual override control of the towed vehicle controller 102. For instance, the towing vehicle and/or towed vehicle controller 102 may comprise a user interface for a manual override of the towing vehicle brakes. The interfaces may comprise, for example, a manual slide having a linear travel potentiometer, controlled by the towing vehicle operator. It is noted that the manual control may be integrated with the towing vehicles control panel. The manual control may apply input to the trailer brake controller component 210 via, for instance, the CAN 140. This input to the trailer brake controller component 210 allows the operator to manually apply towed vehicle brakes without having to depress the brake pedal of the towing vehicle and/or to manual increase or decrease braking. The manual override control, moreover, may be utilized in conjunction with the gain adjustment buttons to calibrate maximum towed vehicle braking available based on specific towed vehicle loading, towed vehicle tire and brake conditions, and road conditions. Normal maximum is that braking force that is just short of causing the wheels of the towed vehicle to skid. When the operator activates the manual override control, the trailer brake controller component 210 sends a signal over the communication bus to the trailer brakes 114. Additionally, whenever there is a normal braking event for the towed vehicle, e.g., the operator depressing the brake pedal of the towing vehicle, a signal is also sent to the towing vehicle from the brake trailer brake controller component 210 via the communication bus.

The towed vehicle controller 102 may also be capable of: sending signals to the brakes of the towed vehicle; sending signals to the stoplight of the towed vehicle, including stoplight power; sending other signals to the towed vehicle; and sending signals to the towing vehicle. It is noted, however, that the processor 150 may control the trailer lighting component 240 independent of the trailer brake controller component 210. For instance, a towed vehicle may have lights but may not have its own brakes. As such, the processor 150 may control the lights of the towed vehicle independent of braking functions of the towed vehicle.

The trailer brake controller component 210 may also be capable of receiving information regarding the ignition of the towing vehicle. While specific embodiments of a trailer brake controller component 210 are disclosed these are exemplary and not exhaustive. Any brake controller configuration may be utilized with the present system.

As described herein, the towed vehicle controller 102 can be fully integrated with the towing vehicle. This allows the towed vehicle controller 102 to be originally installed equipment in a towing vehicle. In other words, the towed vehicle controller 102 can be a factory-installed option on a towing vehicle. In such circumstances, the displays and the controls for the towed vehicle controller 102 may be integrated into the instrument panel of the towing vehicle. As such, it is important that the controls operate similarly to the other controls contained in the towing vehicle's instrument panel. In particular, automatic dimming and light harmony with the dash lighting elements is important.

Accordingly, the towed vehicle controller 102 incorporates a mechanism via software and hardware interface to adjust the lighting intensity of the displays to coordinate with the intensity of the dash lighting elements of the towing vehicle. The adjustment of the towed vehicle controller 102 display is triggered through a message list being received via the towing vehicle communication bus (e.g., CAN 140). This adjustment is controlled through communication with the display driver and the display elements, such as by connection component 106 (e.g., which may comprise a serial bus or the like). Through a series of commands the functionality of the display, for example, dimming, blinking, setting element values, scrolling, etc., can be modified. For example, gain buttons or other user interfaces on the towed vehicle controller 102 are backlit to assist the operator in locating these adjustment devices. The intensity of the back lighting is also varied based on the operator's adjustment of the interior dash light adjustment of the towing vehicle.

It is further noted that the display and the intensity of the lights of the towed vehicle controller 102 may be automatically adjusted via sensors or timers. For instance, a towed vehicle may include light sensors that operatively adjust the intensity of lights on a dash or control panel. The CAN 140 may send a control signal to the towed vehicle controller 102 indicating the desired intensity of the lights of the towed vehicle controller 102. The towed vehicle controller 102 may operatively adjust the lighting based on the received signal. It is noted, however, that the display lighting may be controlled by another device of the system 100, such as a controller external to the towed vehicle controller 102. By way of example, the display and intensity of the lights of the towed vehicle controller 102 may darken when the ambient light lowers such as night and may brighten in the day when the ambient light increases. The present teachings are not limited to such, the opposite may apply, i.e., the towed vehicle controller 102 display and light intensity may increase when the ambient light decreases and may decrease when the ambient light increases.

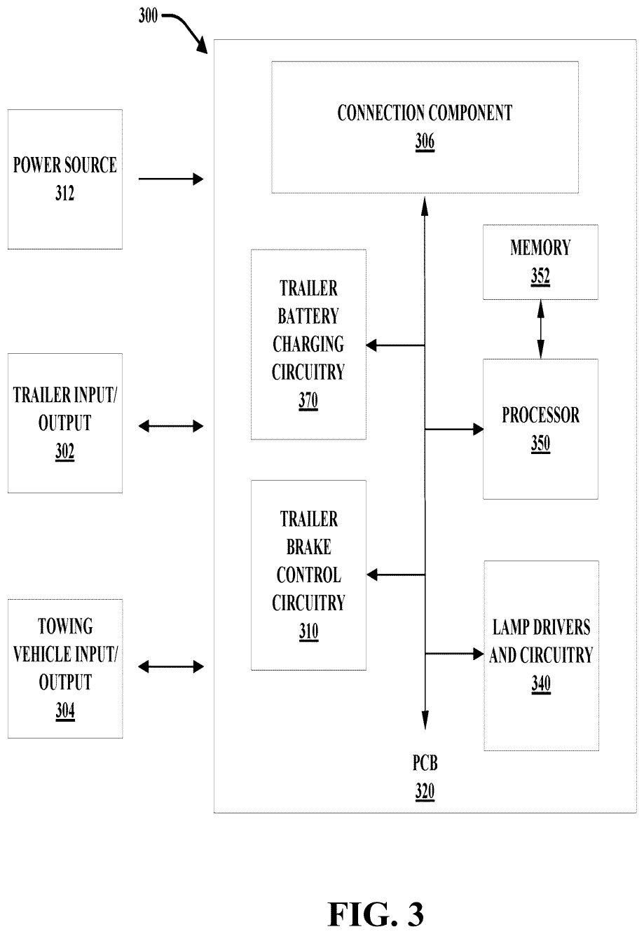

Turning to FIG. 3, there is an exemplary block schematic of a towed vehicle controller 300. It is noted that the towed vehicle controller 300 may comprise similar or different aspects as described with reference to towed vehicle controller 102 of FIGS. 1-2. The towed vehicle controller 300 primarily comprises a printed circuit board (PCB) 320, a connection component 306 (e.g., which may comprise aspects of connection component 106), trailer brake control circuitry (e.g., which may comprise aspects of brake controller component 210), lamp drivers and circuitry 340 (e.g., which may comprise aspects of trailer lighting component 240), trailer battery control circuitry 310 (e.g., which may comprise aspects of trailer battery charge component 270), and a processor 350 coupled to memory 352. While the various circuits and components of towed vehicle controller 300 are shown as mounted or coupled to a single PCB 320, it is noted that the various circuits and components of towed vehicle controller 300 may be mounted on separate PCBs that, in-turn, are couple together. Moreover, the towed vehicle controller 300 may comprise various other circuits or components in accordance with this disclosure.

It is noted that the towed vehicle controller 300 may be in communication with a power source 312 to provide power to the circuitry and a towed vehicle. For instance, the towed vehicle controller 300 may operatively provide power to a trailer via trailer input/output 302.

The towed vehicle controller 300 operatively communicates with the towing vehicle via towing vehicle input/output 304 and the towed vehicle via trailer input/output 302. In embodiments, all towing vehicle input/output 304 and signals may pass through connection component 306. In another aspect, the connection component 306 may comprise a connector for a network bus, such as a CAN bus.

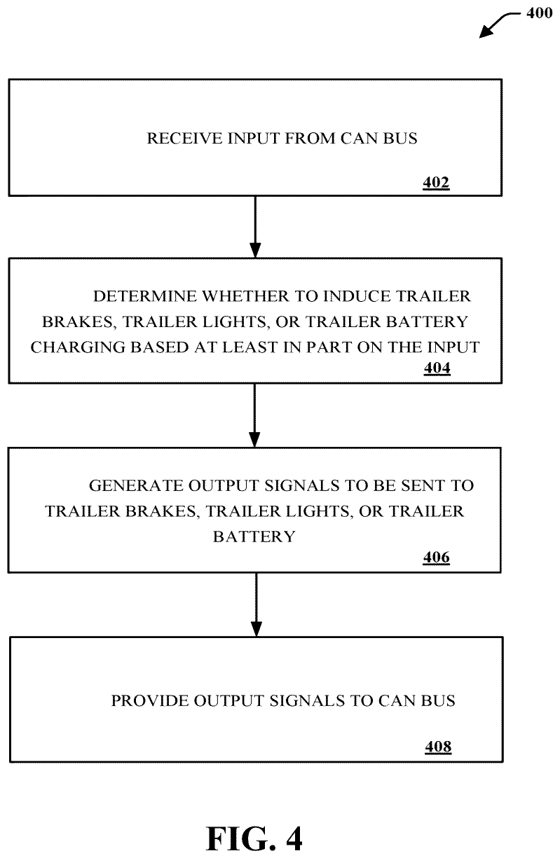

In view of the subject matter described herein, methods that may be related to various embodiments may be better appreciated with reference to the flowchart of FIG. 4. While the method 400 is shown and described as a series of blocks, it is noted that associated methods or processes are not limited by the order of the blocks. It is further noted that some blocks and corresponding actions may occur in different orders or concurrently with other blocks. Moreover, different blocks or actions may be utilized to implement the methods described hereinafter. Various actions may be completed by one or more users, mechanical machines, automated assembly machines (e.g., including one or more processors or computing devices), or the like.

At 402, a system (e.g., towed vehicle control system 100) may receive input from CAN bus. For instance, a towed vehicle controller may receive input via a communication component. The input may relate to user actions (e.g., brake application, turn signal activation, gain/sensitivity adjustments), sensed parameters from a towing vehicle (e.g., ABS sensors, wheel speed sensors, light sensors, etc.), or the like.

At 404, the system may determine whether to induce trailer brakes, trailer lights, or trailer battery charging based at least in part on the input. As described herein, a towed vehicle controller may determine whether to apply brakes of a trailer, activate trailer lights, and/or activate/disable charging of a trailer battery.

At 406, the system may generate output signals to be sent to trailer brakes, trailer lights, or trailer battery. The output signal may be of an appropriate form and may carry information. In an aspect, the system may output signals that induce an amount of braking, lights to activate and/or a battery to charge.

At 408, the system may provide output signals to a CAN bus. For instance, the system may receive feedback information regarding diagnostics, status, brake application, light actuation, battery charging, or the like. The system may process the information and may generate an appropriate output, such as output to control a display.

It should be understood that the foregoing description is a description of an exemplary brake controller. The present teachings are not limited to the embodiment disclosed above. Any configuration of brake controller may be utilized without departing from the present teachings.

Modification of the disclosure will occur to those skilled in the art and to those who make or use the disclosure, including, without limitation, the values provided for the various elements disclosed above. It should be understood that such values are exemplary values and the present disclosure is not limited to those values. Therefore, it is understood that the embodiments shown in the drawings and described above are merely for illustrative purposes and not intended to limit the scope of the disclosure, which is defined by the following claims as interpreted according to the principles of patent law, including the Doctrine of Equivalents.

Although the embodiments of this disclosure have been illustrated in the accompanying drawings and described in the foregoing detailed description, it is to be understood that the present disclosure is not to be limited to just the described embodiments, but that the embodiments described herein are capable of numerous rearrangements, modifications and substitutions without departing from the scope of the claims hereafter. It is, of course, not possible to describe every conceivable combination of components or methodologies for purposes of describing the present specification, but one of ordinary skill in the art may recognize that many further combinations and permutations of the present specification are possible. Each of the components described above may be combined or added together in any permutation to define a blending system. Accordingly, the present specification is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim. The claims as follows are intended to include all modifications and alterations insofar as they come within the scope of the claims or the equivalent thereof

1-9. (canceled)

10. A method for controlling braking and lighting of a towed vehicle, the method comprising:
receiving, via a communication bus or other input interface of a towing vehicle, one or more input signals associated with at least one of braking effort, lighting commands, sensed towing-vehicle parameters, or operator-selected adjustments;
processing, by a processor of a towed vehicle controller comprising a brake controller component and a trailer lighting component, the one or more input signals to determine whether to induce trailer braking or trailer lighting activation;
generating, by the processor, one or more output control signals associated with trailer braking or trailer lighting activation; and
transmitting the one or more output control signals to at least one of trailer brakes or trailer lights through a connection component of the towed vehicle controller.

11. The method of claim 10, wherein the towed vehicle controller is integrated as original equipment of the towing vehicle within a factory-installed enclosure that interfaces with towing-vehicle interior lighting, instrument-panel controls, and vehicle display modules through the communication bus.

12. The method of claim 10, wherein receiving the one or more input signals comprises receiving signals from at least one of:
(i) a Local Interconnect Network (LIN) interface,
(ii) a wireless transceiver,
(iii) a Controller Area Network (CAN) interface, or
(iv) one or more discrete or analog circuits,
each operatively coupled to the connection component of the towed vehicle controller.

13. The method of claim 10, further comprising controlling charging of a trailer battery by generating a processor-controlled charge output based at least on towing-vehicle battery demand, trailer-battery voltage, or operator-selected charging parameters.

14. The method of claim 10, wherein generating output control signals associated with trailer lighting includes activating one or more dedicated light-driver circuits comprising at least one of a left-turn driver, right-turn driver, tail driver, reverse driver, stop driver, or rear-fog driver.

15. The method of claim 10, further comprising automatically adjusting illumination of trailer lights or user-interface backlighting of the towed vehicle controller in response to dimming commands, ambient-light-based messages, or display-driver instructions received over the communication bus.

16. The method of claim 10, further comprising modifying at least one of a brake output or a lighting output in response to one or more additional sensor inputs received through the communication bus, including inputs associated with proximity sensing, brake-switch state, trailer tire conditions, diagnostic fault states, or reverse-maneuver assist functions.

17. The method of claim 10, further comprising detecting a short-circuit or connectivity fault at one or more trailer circuits using feedback from output/flyback main circuitry and modifying the generated output control signals to reduce duty cycle, disable affected outputs, or report a diagnostic condition.

18. The method of claim 10, further comprising activating a stop-lamp driver whenever the processor generates a brake control signal for the trailer brakes, independent of towing-vehicle lighting commands.

19. A method for determining and applying brake output to a towed vehicle, the method comprising:
receiving, at a processor of a towed vehicle controller, input signals comprising at least one of a brake pressure transducer signal, towing-vehicle ABS information, towing-vehicle wheel speed information, inclination, acceleration, or operator-selected brake parameters;
selecting, by the processor, a braking algorithm from among a plurality of stored braking algorithms based at least on the received signals;
computing a brake control output comprising a pulse-width-modulated signal defining an amount and timing of braking to apply;
transmitting the brake control output to brake output circuitry configured to vary current or voltage delivered to trailer brakes; and
inducing braking at the trailer brakes based on the brake control output,
wherein the braking algorithm is modified based on lighting-state information or trailer connectivity diagnostics.

20. The method of claim 19, wherein selecting the braking algorithm comprises accessing a lookup table stored in memory that includes a plurality of braking-algorithm profiles, each profile defining a set of braking curves, braking responses, or duty-cycle mappings associated with respective operating conditions of the towing vehicle or towed vehicle, and selecting one of the braking-algorithm profiles based on at least one of towing-vehicle configuration, trailer configuration, sensed vehicle dynamics, or operator-selected parameters.

21. The method of claim 19, further comprising receiving a manual override input and causing the towed vehicle controller to apply braking independent of towing-vehicle brake-pedal actuation.

22. The method of claim 19, further comprising scaling the brake control output based on towing-vehicle speed so that braking strength is reduced at lower speeds and increased toward full output at higher speeds.

23. The method of claim 19, further comprising modifying the brake control output during an ABS event based on wheel-slip conditions such that braking is maintained on high-p surfaces or reduced on low-p surfaces.

24. The method of claim 19, further comprising applying a gain multiplier to the computed duty cycle such that the resulting brake control output scales proportionally to an operator-selected gain setting.

25. A method for coordinating trailer braking and trailer lighting, the method comprising:
receiving, at a towed vehicle controller, one or more communication inputs associated with a towing vehicle, the one or more communication inputs being received via at least one of (i) a towing-vehicle communication bus, (ii) a connection component, or (iii) one or more discrete or analog inputs;
determining, by a processor, a braking state of the towing vehicle and one or more lighting functions associated with the towed vehicle;
coordinating, by the processor, the operation of a trailer brake driver circuit and a plurality of trailer light driver circuits based at least on towing-vehicle inputs or operator-selected settings; and
transmitting coordinated control signals to the trailer brake driver circuit and the plurality of trailer light driver circuits.

26. The method of claim 25, further comprising transmitting status information including trailer connectivity, braking level, light activation, or battery-charging status to a towing-vehicle display via the communication bus.

27. The method of claim 25, further comprising modifying the coordinated control signals in response to ABS information or wheel-speed information received via the communication bus, including activation of stop or hazard lamps during ABS braking events.

28. The method of claim 25, wherein coordinating brake and light activation comprises executing one of multiple stored coordination algorithms selected based on trailer configuration or market-specific lighting rules.

29. The method of claim 25, further comprising updating one or more stored algorithms of the towed vehicle controller via the communication bus or a wireless interface and executing the updated algorithms during subsequent braking or lighting operations.
